(19) United States
(12) Patent Application Publication
(10) Pub. No.: US 2019/0080471 A1
(43) Pub. Date: Mar. 14, 2019

(54) DISTANCE MEASUREMENT SYSTEM AND DISTANCE MEASUREMENT METHOD

(71) Applicant: Fanuc Corporation, Yamanashi (JP)

(72) Inventor: Muneyuki TSUDA, Yamanashi (JP)

(73) Assignee: Fanuc Corporation, Yamanashi (JP)

(21) Appl. No.: 16/059,650

(22) Filed: Aug. 9, 2018

(30) Foreign Application Priority Data
Sep. 11, 2017 (JP) JP2017-173709

(51) Int. Cl. G06T 7/73; H04N 5/232

(52) U.S. Cl. CPC G06T 7/74; G05B 2219/40564; G05B 2219/37555; H04N 5/23229

(57) ABSTRACT

A distance measurement system includes: a camera that captures an object; a robot that moves the camera or the object; and a control unit that controls the robot. The control unit includes: an operation control unit that operates the robot so that the camera or the object is located in a rectilinearly moved state between two different image-capturing positions at which a prescribed position on the object in the image obtained by the camera is located at the center of the image; a size calculating unit that calculates sizes of the object in the images obtained by the camera at the two image-capturing positions; and a distance calculating unit that calculates a distance from the camera to the object on the basis of the sizes of the object at the two image-capturing positions, calculated by the size calculating unit, and the distance between the two image-capturing positions.

### CROSS-REFERENCE TO RELATED APPLICATIONS

This application is based on Japanese Patent Application No. 2017-173709, the contents of which are incorporated herein by reference.

### TECHNICAL FIELD

The present invention relates to a distance measurement system and a distance measurement method.

### BACKGROUND ART

Known techniques for measuring the distance from a camera to an object to be captured with the camera include a method in which two cameras are used, and a method in which the size of the object in a captured image is identified (for example, see Patent Literature 1).

### CITATION LIST

### Patent Literature

### {PTL 1}

Japanese Unexamined Patent Application, Publication No. HEI 9-170920

### SUMMARY OF INVENTION

The present invention provides the following solutions.

A first aspect of the present invention provides a distance measurement system including: a camera that captures an object to obtain an image; a robot that moves the camera or the object; and a control unit that controls the robot. The control unit includes: an operation control unit that operates the robot so that the camera or the object is located in a rectilinearly moved state between two different image-capturing positions at which a prescribed position on the object in the image obtained by the camera is located at the center of the image; a size calculating unit that calculates sizes of the object in the images obtained by the camera at the two image-capturing positions; and a distance calculating unit that calculates a distance from the camera to the object on the basis of the sizes of the object at the two image-capturing positions, calculated by the size calculating unit, and the distance between the two image-capturing positions.

Another aspect of the present invention is a distance measurement method including: a first moving step of operating a robot to move an object or a camera so that the object and the camera are located at a first image-capturing position at which a prescribed position on the object in an image obtained by the camera is located at the center of the image; a first image-capturing step of capturing the object with the camera at the first image-capturing position to obtain the image; a second moving step of operating the robot to move the object or the camera so that the camera or the object undergoes rectilinear motion with respect to the first image-capturing position to locate the object and the camera at a second image-capturing position at which the prescribed position in the image obtained by the camera is located at the center of the image; a second image-capturing step of capturing the object with the camera at the second image-capturing position to obtain the image; a size calculating step of calculating sizes of the object in the images obtained at the first image-capturing position and the second image-capturing position; and a distance calculating step of calculating a distance from the camera to the object on the basis of the calculated sizes of the object in the images and the distance between the first image-capturing position and the second image-capturing position.

### BRIEF DESCRIPTION OF DRAWINGS

FIG. 1 is a schematic diagram showing a distance measuring system according to the present embodiment.

FIG. 2 is a block diagram of the distance measuring system according to the present embodiment.

FIG. 3 is a conceptual diagram showing the positional relationship of an object in images captured by a camera.

FIG. 4 is a diagram for explaining a method of calculating the distance from the camera to the object.

FIG. 5 is a flowchart of the distance measurement method for calculating the distance from the camera to the object.

### DESCRIPTION OF EMBODIMENTS

A distance measurement system 1 according to an embodiment of the present invention will be described below with reference to the drawings.

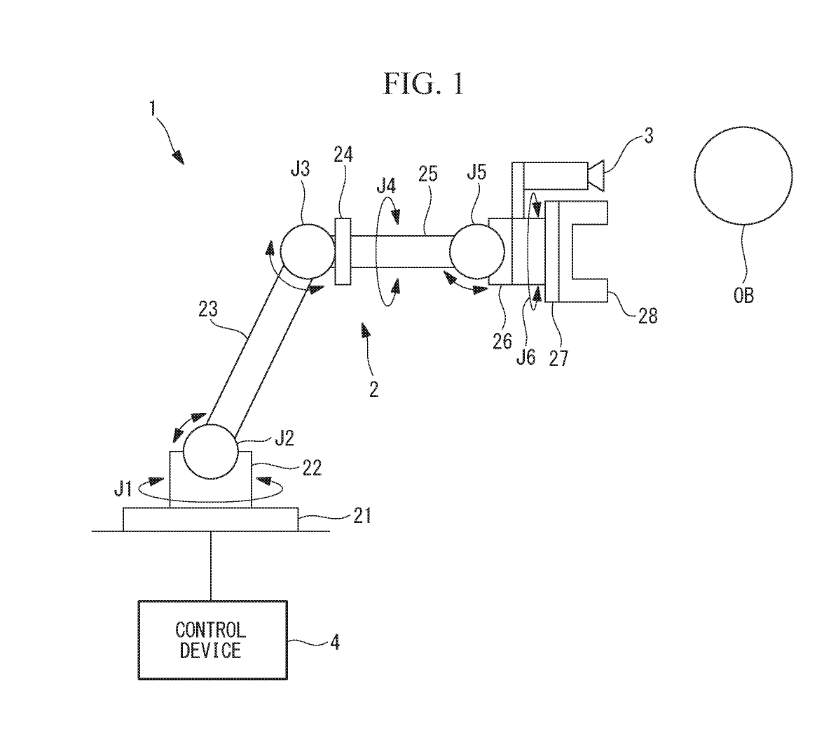

FIG. 1 is a schematic diagram showing the distance measurement system 1 according to this embodiment. The distance measurement system 1 is provided with: a robot 2 such as an upright multijoint robot having six axes J1-J6; a camera 3 that is attached to the distal end of the robot 2 and that captures an image of an object OB; and a control device (control unit) 4 that performs control of the robot 2 and image processing of the images obtained by the camera 3.

The robot 2 includes: a base 21 that is fixed to the floor; a rotating body 22 that is supported so as to be rotatable relative to the base 21 about a vertical first axis J1; a first arm 23 that is supported so as to be rotatable relative to the rotating body 22 about a horizontal second axis J2; a second arm 24 that is supported so as to be rotatable relative to the first arm 23 about a horizontal third axis J3; a first wrist element 25 that is supported so as to be rotatable relative to the second arm 24 about a fourth axis J4 that is perpendicular to the third axis J3; a second wrist element 26 that is supported so as to be rotatable relative to the first wrist element 25 about a fifth axis J5 that is perpendicular to the fourth axis J4; and a third wrist element 27 that is supported so as to be rotatable relative to the second wrist element 26 about a sixth axis J6 that is perpendicular to the fifth axis J5.

The six axes J1-J6 are each provided with a motor (not illustrated) for rotational driving and an encoder (not illustrated) for detecting the rotational angle of the motor. The camera 3 is fixed to a distal end face of the third wrist element 27, which rotates about the sixth axis J6. Reference sign 28 in the figure is a tool, such as a hand or the like, that is fixed to the distal end face of the third wrist element 27.

The control device 4 performs feedback control for rotationally driving the motor, using the motor rotation angles detected by the encoders for the axes J1-J6. The control device 4 is formed of a CPU, a ROM, a RAM, and a memory (not illustrated).

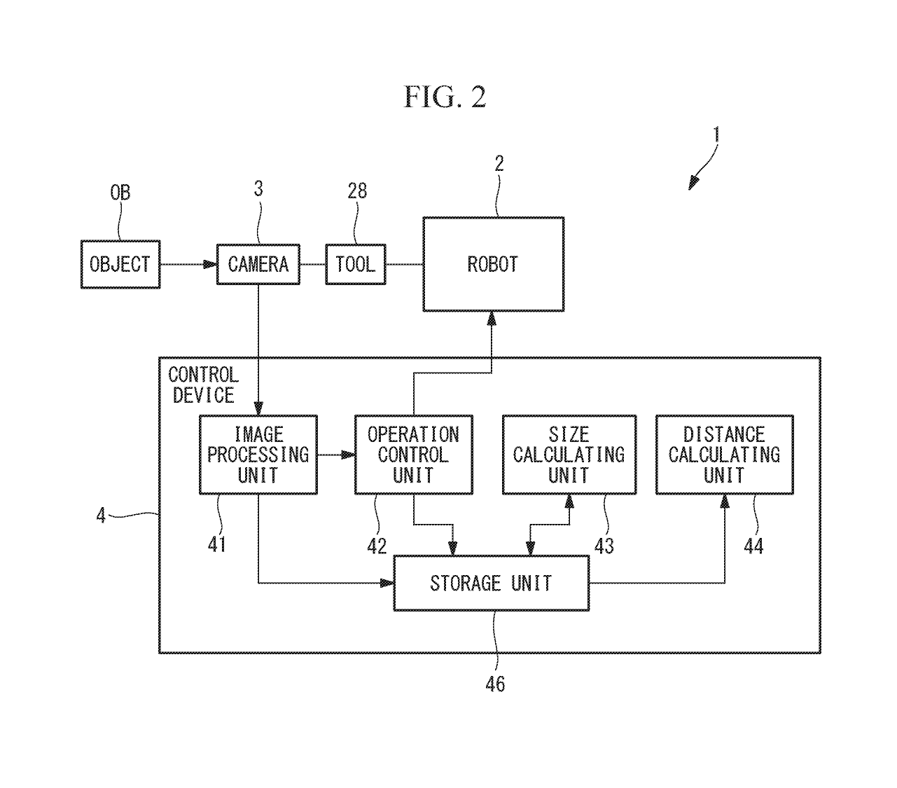

As shown in FIG. 2, the control device 4 is provided with: an image processing unit 41 that performs image processing of the image obtained by the camera 3; an operation control unit 42 that drives the robot; a size calculating unit 43 that calculates the size of the object OB in the image obtained by the camera 3; a distance calculating unit 44 that calculates the distance from the camera 3 to the object OB; and a storage unit 46 that stores the results of various kinds of processing. Strictly speaking, the distance from the camera 3 to the object OB is the distance from the center of the lens of the camera 3 to the object OB, but hereinafter, it is simply referred to as the distance from the camera 3 to the object OB.

The image processing unit 41, by using edge detection or pattern matching, extracts the object OB from the image obtained by the camera 3 and identifies the center of gravity of the extracted object OB. The image processing unit 41 stores the obtained image, the object OB in the image, and the center of gravity of the object OB in the storage unit 46.

The operation control unit 42 operates the robot 2 by driving the motors for the axes J1-J6 in the robot 2 on the basis of various control signals. First, the operation control unit 42 operates the robot 2 to set the robot at an initial position at which the object OB is included within the image-capturing range of the camera 3. The operation control unit 42 operates the robot 2 to move the camera 3 so that the center of gravity of the object OB in the image obtained by the camera 3 is located at the center of the image. When the robot 2 is operated so that the camera 3 is located at a first image-capturing position at which the center of gravity of the object OB in the image is located at the center of the image, image capturing is performed by the camera 3, and an image including the object OB is obtained.

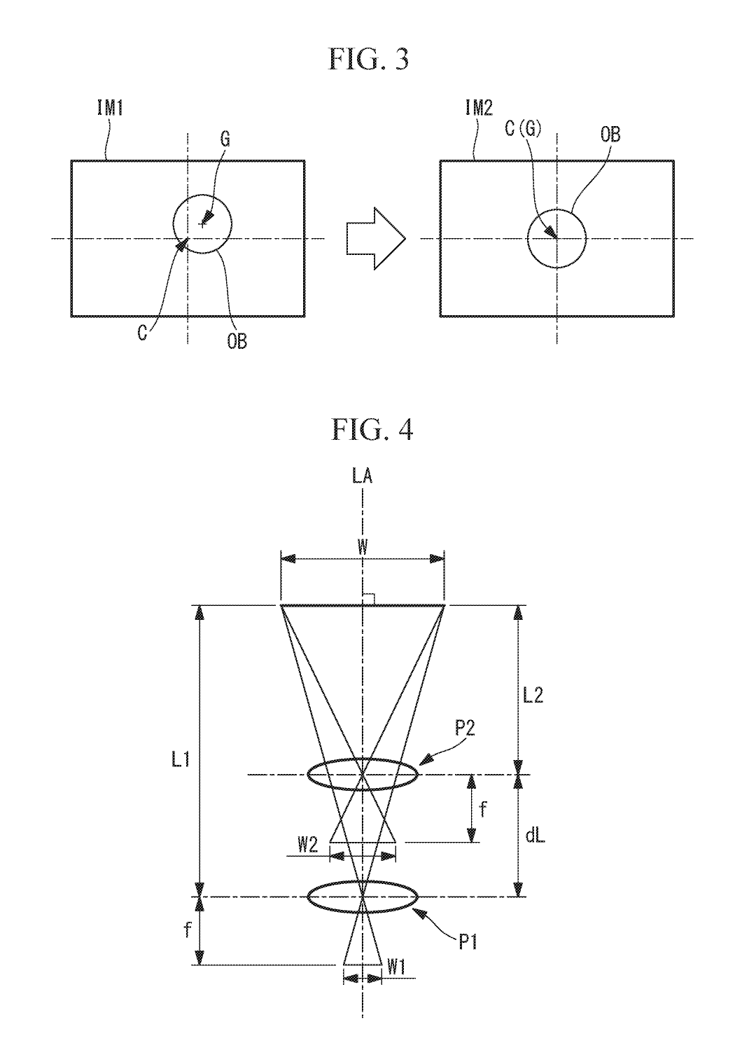

FIG. 3 is a conceptual image showing the positional relationship of the object OB within the image captured by the camera 3. In an image IM1 obtained by the camera 3 at the initial position of the robot 2, shown in FIG. 3, the center of gravity G of the object OB is not located at the center C in the image IM1. In this case, the operation control unit 42 operates the robot 2 to change the position of the camera 3 from the initial position, so that the center of gravity G of the object OB is located at the center C of the image IM1. As a result, the center of gravity G of the object OB is located at the center C of the image IM2, as in the image IM2 shown in FIG. 3.

Furthermore, the operation control unit 42 stores, in the storage unit 46, angle information of the axes J1-J6 of the robot 2 at the first image-capturing position at which the first image is obtained. Next, the operation control unit 42 operates the robot 2 to cause the camera 3 to undergo rectilinear motion in a direction such that the camera 3 approaches or moves away from the object OB.

After the operation control unit 42 operates the robot 2 so that the camera 3 undergoes rectilinear motion, image capturing is performed by the camera 3, and an image including the object OB is obtained. The operation control unit 42 determines whether or not the center of gravity G of the object OB is located at the image center C in the obtained image. If the operation control unit 42 determines that the center of gravity G of the object OB is located at the center C of the obtained image, the obtained image is obtained as a second image, and the position at which the second image is obtained is stored in the storage unit 46 as a second image-capturing position. The operation control unit 42 stores, in the storage unit 46, the angle information of the axes J1-J6 of the robot 2 at the second image-capturing position.

If the operation control unit 42 determines that the center of gravity G of the object OB is not located at the center C of the image, supplemental processing is executed to operate the robot 2 and make the camera 3 undergo rectilinear motion so that the center of gravity G of the object OB in the image obtained by the camera 3 is located at the center C of the image, as shown in FIG. 3. Once the center of gravity G of the object OB is located at the center C of the image, image capturing is performed by the camera 3, and an image including the object OB is obtained as a second image. The operation control unit 42 stores, in the storage unit 46, the angle information of the axes J1-J6 of the robot 2 at the second image-capturing position at which the second image is obtained.

With the distance measurement system of this embodiment, since calibration is not performed, a tool coordinate system of the tool 28 attached to the distal end of the third wrist element 27 in the robot 2 is not associated in advance with the optical axis of the camera 3. On the other hand, because the center of gravity G of the object B is located at the image center C in the first image, the center of gravity G of the object OB is on the optical axis of the camera 3. After the robot 2 is operated so that the camera 3 undergoes rectilinear motion from the state in which the center of gravity G of the object OB is on the optical axis of the camera 3, in the second image obtained by the camera 3, the center of gravity G of the object OB is on the optical axis of the camera 3.

In other words, before and after the robot 2 is operated so that the camera 3 undergoes rectilinear motion from the first image-capturing position to the second image-capturing position, the object OB captured by the camera 3 is on the optical axis of the camera 3. Because of this, the change in position from the first image-capturing position to the second image-capturing position can effectively be regarded as a change along the optical axis of the camera 3.

The optical axis direction of the camera 3 in this embodiment is defined as the direction of a straight line connecting the lens center of the camera 3 and the image center; however, in another embodiment, an optical axis direction that differs from that in this embodiment may be set so long as the distance between the camera 3 and the object OB can effectively change along the defined optical axis direction.

The size calculating unit 43 calculates the sizes of the object OB in the first image and the second image. In this embodiment, the size calculating unit 43 calculates, as the area, the number of pixels occupied by the object OB in the image and treats the square root of this area as the size. The size calculating unit 43 stores, in the storage unit 46, the calculated sizes of the object OB in the first image and the size of the object OB in the second image.

The distance calculating unit 44 uses the angle information of the axes J1-J6 of the robot 2 at the first image-capturing position and the second image-capturing position, said angle information being stored in the storage unit 46, to calculate the moving distance of the robot 2 along the optical axis direction of the camera 3 from the first image-capturing position to the second image-capturing position.

The distance calculating unit 44 uses the calculated moving distance, as well as the size of the object OB in the first image and the size of the object OB in the second image, to calculate the distance from the camera 3 to the object OB.

FIG. 4 shows various dimensional relationships in the case where the robot 2 approaches the object OB. As shown in FIG. 4, for each distance along the optical axis LA, the distance from the camera 3 to the object OB at the first image-capturing position P1 is defined as the distance before movement L1, the distance from the camera 3 to the object OB at the second image-capturing position P2 is defined as the distance after movement L2, the distance moved by the robot 2 from the first image-capturing position P1 to the second image-capturing position P2 is defined as the moving distance (distance between the two image-capturing positions) dL, and the focal distance of the lens in the camera 3 is defined as the focal distance f. In addition, regarding the sizes in a planar direction perpendicular to the optical axis direction LA, when the actual size of the object OB is defined as size W, the size of the object OB in the first image is defined as size W1, and the size of the object in the second image is defined as size W2, the relationships in the following equations (1) to (3) are satisfied:

{MATH 1}

dL=L1−L2 (1)

W:W1=L1:f (2)

W:W2=L2:f (3)

Using equations (1) to (3), when the actual size W of the object OB and the focal distance f are eliminated, the distance after movement L2 from the camera 3 to the object OB at the second image-capturing position P2 can be expressed with equation (4) below:

$$\begin{matrix}[ MATH 2 ] & \\ L 2 = d L \frac{W 1}{W 2 - W 1} & ( 4 )\end{matrix}$$

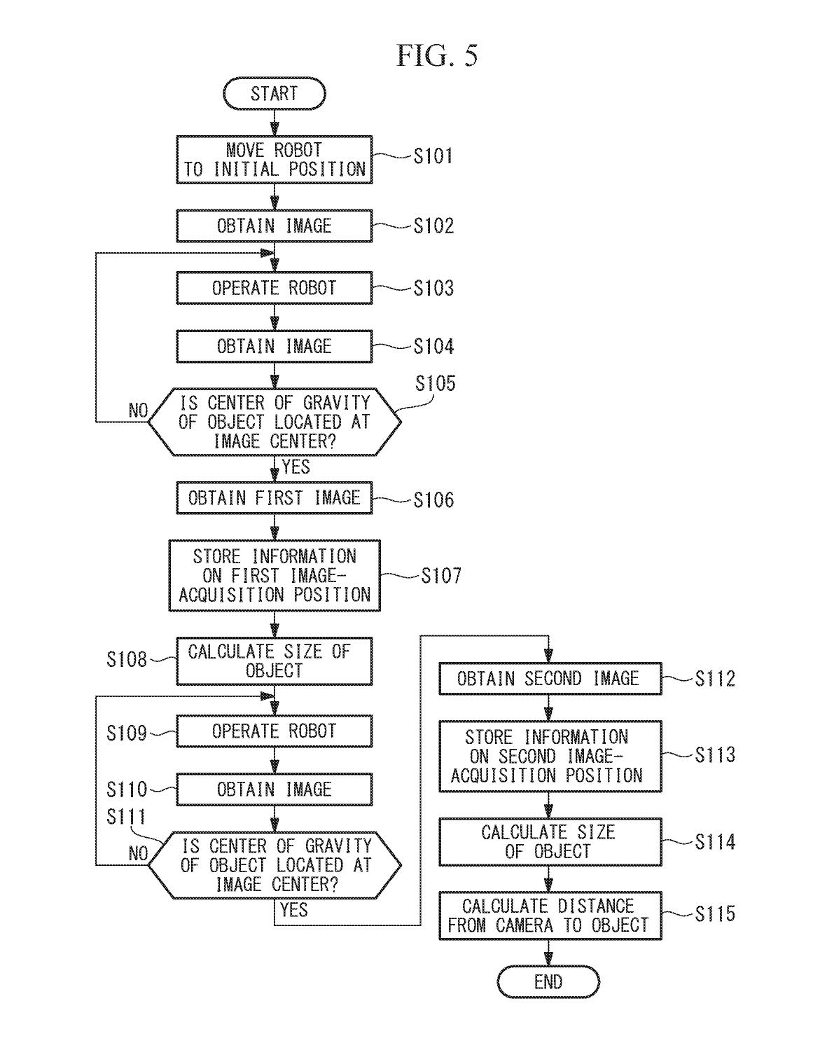

Next, an example of the actual processing up to calculation of the distance from the camera 3 to the object OB will be described by following the flowchart of the distance measurement method shown in FIG. 5. In the distance measurement processing, first, the robot 2 is moved to the initial position by the operation control unit 42 so that the object OB is included in the region captured by the camera 3 (step S101). After the robot 2 is moved, the object OB is captured by the camera, and an image is obtained (step S102).

The robot 2 is operated by the operation control unit 42 so that the center of gravity G of the object OB is located at the center of the image obtained by the camera 3 (step S103). After the robot 2 is operated, an image including the object OB is obtained by the camera (step S104).

The operation control unit 42 determines whether or not the center of gravity G of the object OB in the obtained image is located at the image center C (step S105). If the operation control unit 42 determines that the center of gravity G of the object OB is not located at the image center C (step S105: NO), the processing from step S103 onward is repeated until the center of gravity G of the object OB is located at the image center C. Here, the center of gravity G being located at the center C, as well as meaning that the center of gravity G and the center C are coincident, also means that the distance between the two approaches a prescribed distance or less.

In the processing in step S105, if the operation control unit 42 determines that the center of gravity G of the object OB is located at the image center C (step S105: YES), a first image including the object OB is obtained by the camera 3 as the image at the first image-capturing position P1 (step S106).

As the information indicating the first image-capturing position, the angle information of the axes J1-J6 is stored in the storage unit 46 (step S107). The size calculating unit 43 calculates the size W1 of the object OB in the first image (step S108).

The robot 2 is operated by the operation control unit 42 so that the camera 3 undergoes rectilinear motion in approximately the optical axis direction of the camera 3 (step S109). After the camera 3 is made to undergo rectilinear motion by the robot 2, an image including the object OB is obtained by the camera 3 (step S110). The operation control unit 42 determines whether the center of gravity G of the object OB in the obtained image is located at the image center C (step S111). If the operation control unit 42 determines that the center of gravity G of the object OB is not located at the image center C (step S111: NO), the processing from step S109 onward is repeated until the center of gravity G of the object OB is located at the image center C.

In the processing in step S111, if the operation control unit determines that the center of gravity G of the object OB is located at the image center C (step S111: YES), the second image including the object OB is obtained by the camera 3 as the image at the second image-capturing position P2 (step S112).

When the second image is obtained (step S112), the operation control unit 42 stores, in the storage unit 46, the angle information of the axes J1-J6 as the information indicating the second image-capturing position of the robot 2 at which the second image is obtained (step S113). The size calculating unit 43, similarly to the processing in step S108, calculates the size W2 of the object in the second image (step S114).

For the moving distance dL of the robot 2, which is calculated on the basis of the information indicating the first image-capturing position P1 of the robot 2 and the information indicating the second image-capturing position P2, as well as the size W1 of the object OB in the first image and the size W2 of the object OB in the second image, the distance calculating unit 44 uses equation (4) above to calculate the distance after movement L2 from the camera 3 to the object OB at the second image-capturing position P2 (step S115), thus completing the distance measurement method.

With the thus-configured distance measurement method according to this embodiment, when the robot 2 is operated so that the camera 3 undergoes rectilinear motion from the first image-capturing position to the second image-capturing position, at either image-capturing position, the center of gravity G of the object OB in the image is located at the image center C. Because of this, after rectilinear motion of the camera 3, the camera 3 effectively moves along the optical axis direction, and the center of gravity G of the object OB is located on the optical axis. Accordingly, the moving distance dL from the camera 3 to the object OB when the image-capturing position changes from the first image-capturing position P1 to the second image-capturing position P2 changes along the optical axis direction LA of the camera 3. By using the sizes W1, W2 of the object OB in the images captured at the first image-capturing position P1 and the second image-capturing position P2, as well as the moving distance dL moved by the robot 2 so that the camera 3 undergoes rectilinear motion, the distance after movement L2 from the camera 3 to the object OB at the second image-capturing position is calculated.

Therefore, with this distance measurement system 1, even though calibration is not performed in advance, it is possible to measure the distance from the camera 3 to the object OB. In addition, because the distance after movement L2 from the camera 3 to the object OB is calculated using the sizes W1, W2 of the object OB in the captured images, it is possible to calculate the distance after movement L2 without any influence of the actual size W of the object OB.

With the distance measurement system 1 according to this embodiment, because the center of gravity G of the object OB is located at the center C of the captured image, a more accurate distance after movement L2 from the camera 3 to the object OB is calculated.

With the distance measurement system 1 according to this embodiment, because the square roots of the areas are used as the sizes W1, W2 of the object OB in the captured images, the error in the calculation of the distance after movement L2 from the camera 3 to the object OB is small.

Although the above embodiment has been described in terms of one form of the method for measuring the distance from the camera 3 to the object OB, which is calculated by the distance measurement system 1, various modifications are possible.

For example, an object OB grasped by the robot 2 may be moved relative to a camera 3 that is fixed at a different position (for example, the floor) from the tool 28 of the robot 2.

In this above embodiment, the robot 2 is operated by the operation control unit 42 so that the center of gravity G of the object OB is located at the image center C; however, the center of gravity G of the object OB need not necessarily be located at the image center C. For example, if the object OB is cube, an apex serving as a feature point of the object OB may be calculated to serve as a prescribed position, and the robot 2 may be operated by the operation control unit 42 so that this apex is located at the center C of the captured image.

In this above embodiment, the square root of the areas in the images are used as the sizes W1, W2 of the object OB; however, regarding the indicators of the sizes W1, W2 of the object OB, various modifications are possible. For example, the maximum lengths of the outlines of the object OB may be used as the sizes W1, W2 of the object OB, or the length of a straight line connecting two feature points may be used.

In the present invention, the operation of the robot 2 so that the camera 3 undergoes rectilinear motion along the optical axis LA of the camera 3 is not necessarily limited to only motion where the moving path of the robot 2 does not deviate from the optical axis LA of the camera 3. In the above embodiment, the operation control unit 42 uses the first image-capturing position P1 and the second image-capturing position P2 of the robot 2 before and after movement to calculate the moving distance dL along the optical axis direction LA of the camera 3. Because of this, even if the robot 2 greatly deviates from the optical axis of the camera 3 while moving from the first image-capturing position P1 to the second image-capturing position P2, by performing the supplemental processing like that from step S109 to step S111 in FIG. 5, the operation of the robot 2, like that to cause the camera 3 to undergo rectilinear motion from the first image-capturing position P1 to the second image-capturing position P2, is set so as to effectively be along the optical axis direction LA of the camera 3.

Besides the case where the robot 2 is operated so that the camera 3 undergoes rectilinear motion from the first image-capturing position P1 to the second image-capturing position P2, any operation of the camera 2 between two image-capturing positions is acceptable, so long as the orientation of the camera 3 at the first image-capturing position P1 and the orientation of the camera 3 at the second image-capturing position P2 have a relationship obtained by rectilinear motion.

In the flowchart shown in FIG. 5, the size W1 of the object OB in the first image is calculated after the first image is obtained by the camera, and the size W2 of the object OB in the second image is calculated after the second image is obtained by the camera 3; however, the steps for calculating the sizes W1, W2 of the object OB are not limited to the order in the flowchart in FIG. 5. For example, the steps for calculating the size W1 of the object OB in the first image and the size W2 of the object OB in the second image may be performed in the directly preceding step in which the distance after movement L2 from the camera 3 to the object OB is calculated.

From the above-described embodiments and modifications thereof, the following aspects of the invention are derived.

A first aspect of the present invention provides a distance measurement system including: a camera that captures an object to obtain an image; a robot that moves the camera or the object; and a control unit that controls the robot. The control unit includes: an operation control unit that operates the robot so that the camera or the object is located in a rectilinearly moved state between two different image-capturing positions at which a prescribed position on the object in the image obtained by the camera is located at the center of the image; a size calculating unit that calculates sizes of the object in the images obtained by the camera at the two image-capturing positions; and a distance calculating unit that calculates a distance from the camera to the object on the basis of the sizes of the object at the two image-capturing positions, calculated by the size calculating unit, and the distance between the two image-capturing positions.

With this aspect, the robot moves the camera or the object, whereby the object is captured with the camera at two image-capturing positions at which the distances from the camera to the object are different, thus obtaining respective images. At each image-capturing position, because the system is set so that a prescribed position on the object in the image is located at the image center, the captured object is located on the optical axis of the camera. In addition, because the camera or the object is located in a rectilinearly moved state at each image-capturing position, images are obtained in the states before and after the object or the camera is made to undergo rectilinear motion along the optical axis of the camera. Because of this, the sizes of the object in the images obtained at the two image-capturing positions are inversely proportional to the distance from the camera to the object. By using this relationship, it is possible to calculate, with superior precision, the distance from the camera to the object by using the sizes of the object in the images at the two image-capturing positions and the distance between the two image-capturing positions.

In other words, with this aspect, it is possible to easily obtain two images before and after the camera or the object is moved along the optical axis direction, while maintaining the orientations of the camera and the object. As a result, it is possible to calculate the distance from the camera to the object even without a complicated system that requires calibration. In addition, because the distance from the camera to the object is calculated by using the sizes of the object in the images, it is possible to calculate the distance without any influence of the actual size of the object.

In the above aspect, the prescribed position may be the center of gravity of the object.

By doing so, the distance from the camera to the object is calculated more accurately in comparison with the case where a position other than the center of gravity of the captured object is located at the image center.

In the above aspect, the size of the object in the image may be a maximum length based on an outline of the object.

By using the maximum length in the outline of the object to determine the size of the captured object, the error in the calculation of the distance from the camera to the object is small. As the maximum length, it possible to use the circumferential length of the outline, the maximum width dimension, or the like.

In the above aspect, the size of the object in the image may be the square root of an area of the object.

By using the square root of the area of the object for determining the size of the captured object, the error in the calculation of the distance from the camera to the object is small.

Another aspect of the present invention is a distance measurement method including: a first moving step of operating a robot to move an object or a camera so that the object and the camera are located at a first image-capturing position at which a prescribed position on the object in an image obtained by the camera is located at the center of the image; a first image-capturing step of capturing the object with the camera at the first image-capturing position to obtain the image; a second moving step of operating the robot to move the object or the camera so that the camera or the object undergoes rectilinear motion with respect to the first image-capturing position to locate the object and the camera at a second image-capturing position at which the prescribed position in the image obtained by the camera is located at the center of the image; a second image-capturing step of capturing the object with the camera at the second image-capturing position to obtain the image; a size calculating step of calculating sizes of the object in the images obtained at the first image-capturing position and the second image-capturing position; and a distance calculating step of calculating a distance from the camera to the object on the basis of the calculated sizes of the object in the images and the distance between the first image-capturing position and the second image-capturing position.

With the present invention, a camera can be easily disposed at two image-capturing positions, at which the distance from the camera to an object is changed along the optical axis direction of the camera while maintaining the orientation of the camera and the object, and as a result, the distance from the camera to the object can be measured without using a complicated system.

### REFERENCE SIGNS LIST

1 distance measurement system
2 robot
3 camera
4 control device (control unit)
42 operation control unit
43 size calculating unit
44 distance calculating unit
IM1, IM2 image
C image center
G center of gravity of object
dL moving distance (distance between two image capturing positions)
L1 distance before movement
L2 distance after movement (distance from camera to object)
OB object
P1 first image-capturing position
P2 second image-capturing position
W actual size of object
W1, W2 size of object in image
S102 first moving step
S106 first image-capturing step
S109 second moving step
S112 second image-capturing step
S108, S114 size calculating step
S115 distance calculating step

1. A distance measurement system comprising:
a camera that captures an object to obtain an image;
a robot that moves the camera or the object;
a control unit that controls the robot; and
wherein the control unit includes an operation control unit that operates the robot so that the camera or the object is located in a rectilinearly moved state between two different image-capturing positions at which a prescribed position on the object in the image obtained by the camera is located at the center of the image, a size calculating unit that calculates sizes of the object in the images obtained by the camera at the two image-capturing positions, and a distance calculating unit that calculates a distance from the camera to the object on the basis of the sizes of the object at the two image-capturing positions, calculated by the size calculating unit, and the distance between the two image-capturing positions.

2. The distance measurement system according to claim 1, wherein the prescribed position is the center of gravity of the object.

3. The distance measurement system according to claim 1, wherein the size of the object in the image is a maximum length based on an outline of the object.

4. The distance measurement system according to claim 1, wherein the size of the object in the image is the square root of an area of the object.

5. A distance measurement method comprising:
a first moving step of operating a robot to move an object or a camera so that the object and the camera are located at a first image capturing position at which a prescribed position on the object in an image obtained by the camera is located at the center of the image;
a first image-capturing step of capturing the object with the camera at the first image-capturing position to obtain the image;
a second moving step of operating the robot to move the object or the camera so that the camera or the object undergoes rectilinear motion with respect to the first image-capturing position to locate the object and the camera at a second image-capturing position at which the prescribed position in the image obtained by the camera is located at the center of the image;
a second image-capturing step of capturing the object with the camera at the second image-capturing position to obtain the image;
a size calculating step of calculating sizes of the object in the images obtained at the first image-capturing position and the second image-capturing position; and
a distance calculating step of calculating a distance from the camera to the object on the basis of the calculated sizes of the object in the images and the distance between the first image-capturing position and the second image-capturing position.
